(19) United States
(12) Patent Application Publication
(10) Pub. No.: US 2005/0106442 A1
(43) Pub. Date: May 19, 2005

(54) Vehicle with a combustion arrangement and a fuel cell device

(76) Inventors: Ulrich Gottwick, Stuttgart (DE); Rainer Saliger, Bamberg (DE)

Correspondence Address: STRIKER, STRIKER & STENBY, 103 EAST NECK ROAD, HUNTINGTON, NY, 11743, US

(21) Appl. No.: 10/961,556

(22) Filed: Oct. 8, 2004

(30) Foreign Application Priority Data
Oct. 9, 2003 (DE) 10346859.5

(51) Int. Cl. H01M 8/04

(52) U.S. Cl. 429/34

(57) ABSTRACT

A vehicle includes a combustion arrangement formed as a motor selected from the group consisting of a gasoline motor and a diesel motor, a waste gas device associated with same combustion arrangement for withdrawal of a waste gas stream, the waste gas device having at least one precipitating unit for precipitation of water from the waste gas stream.

### BACKGROUND OF THE INVENTION

The present invention relates to a vehicle with a fuel cell device and a combustion arrangement.

In modern vehicles, in particular in passenger cars or non passenger cars, it has a relatively great importance whether the fuel cell devices operate with or without a preliminary reforming. It is desired to use the fuel cells for the electrical power supply in a vehicle as so-called APU.

In order to satisfy the combustion motor requirements and requirements for reforming as well as for fuel cells, an optimal integration of both systems in view of efficiency and system simplification is desired.

For the electrical power supply of modern vehicles with combustion motors, in particular with hydrogen, gasoline or diesel motors, the reforming of hydrocarbons in combination with a fuel cell is discussed. As a method for the reforming, the autothermal reforming or in other words the reforming without additional heat demand, or the steam reforming or in other words with heat supply, are considered. As for the fuel cells for the mobile use based on the cycle resistance, the PEM fuel cells are preferable when compared with a SOFC. Both the reforming reaction and the fuel cells require water in this system, for conducting the energy conversion steps as efficient as possible.

Water is produced in the fuel cell by the recombination of hydrogen and oxygen, but however escapes to a greater part as a waste gas from the system. For these reasons under extreme operational conditions, for example high outer temperature, low air moisture, operation of the APU in standing condition, wherein no cooling is possible by a wind ring, a sufficient supply of the system with water can be provided often only with significant expenses or cooling power and system complexity. In particular, in stand-by-operation the water content of a fuel cell in general is not compensated.

Moreover, systems are known which in vehicles with conventional combustion motors without APU or fuel cells, require certain quantities of water for efficiency improvement or emission reduction, as disclosed for example in the patent documents DE 196 22 836 A1 and EP 0 643 801 B1.

### SUMMARY OF THE INVENTION

Accordingly, it is an object of the present invention to provide a vehicle with a combustion arrangement, in particular for producing the drive energy or as standing heating etc., and in some cases with a fuel cell device, wherein the combustion arrangement has a waste gas device for withdrawing a waste gas stream, which provides an improved water management when compared with the prior art.

In keeping with these objects and with others which will become apparent hereinafter, one feature of the present invention resides, briefly stated, in a vehicle, comprising a combustion arrangement formed as a motor selected from the group consisting of a gasoline motor and a diesel motor; a waste gas device associated with said combustion arrangement for withdrawal of a waste gas stream, said waste gas device having at least one precipitating unit for precipitation of water from the waste gas stream.

When the vehicle is designed in accordance with the present invention, the waste gas device has at least one precipitating unit for recovery or precipitation of water from the waste gas stream. Preferably the precipitator has at least one separating element for separation of the precipitated water from the waste gas stream and/or a withdrawal element for withdrawal of the precipitated water, in particular a water conduit and the like.

By means of the precipitating unit in accordance with the present invention, in an advantageous manner the water or the water stream which is contained in the waste gas stream can be provided for different applications in the vehicle or made available “on board”. Thereby a tank for operating water in the vehicle can be completely dispensed with or at least the frequency of the water storage can be significantly reduced.

During the combustion of hydrogen and/or hydrocarbons, such as for example natural gas, kerosene, gasoline or diesel, with air, for example in addition to intermediate/byproducts such as CO or NOₛ, substantially CO₂ and water are produced which leave the system or the vehicle in accordance with the prior through the waste gas device. From one liter of fuel, for example gasoline or diesel, approximately 0.8 kg of water and 2.3 kg of carbon dioxide are produced. The rest of the waste gas of substantially 70 volume percent is composed of nitrogen or nitrogen compounds. In the starting phase of the combustion arrangement or the combustion motor for example approximately 50 ml of gasoline are burned in the first two minutes. This means that in these two minutes approximately 40 ml of water vapor leaves the vehicle with the waste gas stream.

In the prior art during a very short period at the beginning of the starting phase, a part of the water is uncontrollably suppressed on the relatively cold waste gas device or exhaust. This water deposits uncontrollably and leave the vehicle unused together with the waste gas stream. This leads to development of the corrosion of the waste gas device or the exhaust. In accordance with the present invention, this is reduced or completely eliminated so that the service life of the waste gas device or the exhaust is considerably increased.

In accordance with the present invention the water contained in the waste gas stream is separated by means of the precipitator or the separating unit from the waste gas stream and supplied to a corresponding consumer. The precipitation with the inventive precipitator can be performed both in the starting phase and also under normal operational conditions of the combustion arrangement, or in other words at reaching from of its operational temperature with the waste gas temperatures of approximately for example 600° C. or 1000° C.

The water recovered or precipitated with the inventive precipitation unit can be made available to any water consumers in the vehicle. Generally, at least one substantial part of the waste gas device is arranged in a relatively wide lower region of the vehicle. In contrast, in the vehicle the available water consumers frequently are located at a high location of the vehicle. Exactly for these reasons at least one transporting unit for transportation of the precipitated water or pressure generating unit for the precipitated water is advantageous, since thereby the precipitated water of the precipitator can be transported from a lower region of the vehicle to a higher region of the vehicle or to a correspondingly available consumer.

Moreover, by means of the transporting or pressure generating unit a pressure which is substantially higher than the atmospheric pressure can be produced. In some cases, a correspondingly high pressure of the precipitated water can be used advantageously for a application cases. For example water in window and/or windshield wiper devices is provided with an increased pressure. It is recommended to use a precipitation unit in accordance with the present invention also in a vehicle without the fuel cell device.

Advantageously, at least one water storage for intermediate storage of the precipitated water is provided. By means of this feature in particular an advantageous time uncoupling of the water precipitation from the water consumption can be realized. For example the water during the operation, in particular during the travel of the vehicle is precipitated with the inventive precipitator and possibly simultaneously or at a later time point, for example during standing of the vehicle and/of the combustion device, can be utilized.

The water storage can be advantageously used as a buffer element. Advantageously, by means of the correspondingly then mentioned water storage, an operation of the water consumer in the stopping phase of the combustion arrangement is possible over a relatively long time.

In some cases, at least one purification unit for purification of the precipitated water can be provided. It is recommended to preliminarily purify the precipitated water by components of the waste gas stream. Thereby the corresponding preliminarily purified, precipitated water can not affect the water consumer of the vehicle or its operation or damage it. By means of the inventive purification unit in an elegant fashion a corresponding influence or damage of the water consumer is efficiently prevented. For example, the purification unit can be formed as an ion exchange device, a hydrocarbon separating unit, a membrane purification unit or the like.

Preferably, the precipitated water is utilized for the fuel cell device, so that the fuel cell system has a relatively compensated water balance and thereby a relatively frequent post filling of water for the vehicle is avoided. For this purpose between the precipitating unit and the fuel cell device, at least one connecting device for supplying the precipitated water to the separating unit is provided.

In a special embodiment of the present invention, the connecting device between the precipitating unit and the fuel cell unit is arranged. Frequently, the fuel cell unit is formed also as a so-called fuel cell-stack, wherein several individual fuel cells are assembled to form a single assembly. Each fuel cell generally has a membrane, which for its operation as a proton conductor must have a certain moisture. Frequently for this purpose an anode and/or cathode stream before the fuel cell unit is moisturized with water. This water can be made available by means of the inventive precipitator of the fuel cell unit.

Alternatively, or in combination with the previous embodiments, in a further inventive area, the connection device can be arranged between the precipitating unit and a conversion unit for chemical conversion of a fuel into a combustion substance of the fuel cell unit. Conventional conversion units or reformers frequently require water for their objectionable operation, which is made available by means of the inventive precipitator. Also, with this feature the water balance of the fuel cell system is improved in an advantageous manner.

In accordance with the present invention it is possible that the total waste gas stream passes through the precipitation unit to a special further embodiment of the invention, the precipitation unit is arranged at least on a bypass of the waste gas device for producing a waste gas stream. Thereby it is possible that a part of the total waste gas stream flows through the precipitating unit, so that the precipitation unit can be dimensioned as small as possible. Correspondingly both the space consumption and also the financial cost for producing of the precipitation unit are reduced.

Moreover, the energy quantity which is required for the precipitation or liquification, in some cases is reduced, which improves the operation of the precipitation unit. With the use of a partial waste gas stream, in an advantageous manner a reduction of the flow speed of the waste gas can be provided, so that the precipitation or liquification of the water available in the waste gas is further improved.

Generally, the fuel stream quantity which is available with the precipitation unit can be changed by an advantageous regulating or control unit. For example an adaptation to the filling height of the water storage and/or to the (actual) consumption of water in the vehicle is provided. For this purpose different sensors, such as filling, throughflow, moisture, temperature sensors and the like can be utilized in an advantageous manner.

The precipitating unit can recover the water of the waste gas stream by means of different physical or chemical processes. For example it is recommended that the water is recovered by a hydroscopic material in a precipitation phase from the waste gas stream. In a regeneration phase of the precipitation unit, water which is intermediately stored in the hydroscopic material is released and in some cases supplied to the water storage for intermediate storage of the flowing water.

Preferably, the precipitation unit can be formed as a condensation unit for condensation of water. With this feature at least a part of the water steam contained in the waste gas of the combustion arrangement is condensed by means of temperature lowering. The temperatures at the output of a combustion engine amounts to 1000° C. for Otto motors and approximately 600° C. for diesel motors. In the partial load operating pumps, however the waste gas temperatures can be substantially lower. In the output of a waste gas catalyst the temperatures of approximately 200° C. can be provided. Also, in the motor starting phase the waste gasses are significantly colder than in the normal operation. For the liquid separation of water from the waste gas of a combustion motor which typically contains between 7 and 11 volume percent of water steam, for the lowering of the dew point the temperatures under 50° C. are generally required. The further the temperature can be lowered by means of the inventive precipitator, the more water can be withdrawn from the waste gas.

Advantageously, the separating unit includes at least one cooling device for cooling the waste gas stream or the waste gas partial stream. Thereby it is guaranteed that the waste gas or the waste gas partial steam is coolable under the dew point of the water steam. The corresponding cooling device thereby increases the operational safety of the precipitating unit in accordance with the present invention.

For example, the cooling device contains a cooling medium, in particular a cooling gas and/or a cooling fluid. It is recommended for example that the air conditioning devices which are generally used in modern vehicles can include the precipitation unit in accordance with the present invention, or a cooling loop of the air conditioning device is arranged at least partially on or around the waste gas device. Relatively cool air or a cooling medium of the air conditioning device can pass through the cooling loop of the air conditioning device.

Preferably the cooling device includes a blower unit and/or an air deviating device, so that in particular atmospheric air can be flown or supplied to the precipitation unit in a defined or controllable fashion. In general the atmospheric air is significantly cooler than the waste gas stream of the combustion arrangement, so that thereby a significant temperature lowering of the waste gas steam or the waste gas partial steam can be realized.

By means of the deviating and/or guiding devices, a purposeful, local air supply can be produced for example in the lower bottom region of the vehicle at cold location in the waste gas path or in the waste gas device, so that the water steam of the waste gas stream at least partially is condensated. Advantageously this effect can be further improved by thermal bridging or the like.

In a preferable further embodiment of the invention, the cooling device includes at least one cooling element which increases an outer surface. For example, cooling ribs, cooling foam, etc. composed of metal and/or ceramics can lead to a significant increase of the cooling surface of the condensation unit, so that the invention provides local temperature lowering or further improves the condensation.

In a special further embodiment of the present invention, the precipitation unit can be designed in form of a cooled baffle plate or the like, on which the precipitated water is dropped off or guided off and thereby can be separated from the waste gas stream. Thereby in some cases it should be mentioned that a pressure drop in the waste gas line, and/or the noise generation is insignificantly increased.

In an advantageous embodiment of the invention, the precipitating unit is arranged between a catalytically active waste gas element for catalytic conversion of the waste gas stream and an outflow opening of the waste gas device. In general, an arrangement close to the motor is less desirable, since a great temperature lowering must be realized. In other words, the difference between the waste gas temperature and the condensation temperature is greater for condensation of significant quantities of water from the waste gas stream.

Preferably, the precipitation unit is arranged in a flow direction of the waste gas stream behind the last catalyst of the waste gas line or the waste gas device. Partially several catalysts for different waste gas treatment functions can be utilized. An arrangement of a precipitation unit formed as a condensation unit before a corresponding catalyst conventionally would lead to the situation that in some cases the so-called “light-off” temperature of the catalyst is reached later or only conditionally, which affects the waste gas treatment by means of this catalyst. It is recommended during a utilization of another physical or chemical principle for the precipitation of the water, that the precipitation unit is arranged relatively close to the combustion unit or in the flow direction of the waste gas stream before or between one or several waste gas catalysts.

In general, the inventive application of the precipitation unit for the fuel cell device leads to the situation that on the one hand the water balance of the fuel cell system is compensated. On the other hand, the system efficiency for the electrical supply on board is increased, since the peak cooling power for the fuel cell system and in particular a precipitator of the fuel cell, or in other words a second precipitator which is integrated in the fuel cell device, is significantly lowered. For example the cooling system of the fuel cell-APU can be dimensioned smaller and produced less expensive, since the water quantity integrated in the fuel cell device or in other words water produced by the fuel cell device, can be significantly smaller. This can result in the smaller water pumps, coolers of the fuel cell device, etc. Correspondingly, the parasitic powers of the system connected therewith are lower.

Moreover, by the additional water source “on board” of the vehicle, the service life for the pure APU operation is significantly increased.

Basically, the inventive water source can be used also for conventional combustion engine vehicles, possibly also without fuel cells for motor applications or the like, for example comfort applications and, among others, for emission reduction and/or efficiency increase, etc.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a principal diagram of a vehicle in accordance with the present invention; and

FIG. 2 is a view schematically showing a relationship between a temperature in a precipitator in accordance with the present invention and a water content in a waste gas stream.

### DESCRIPTION OF THE PREFERRED EMBODIMENTS

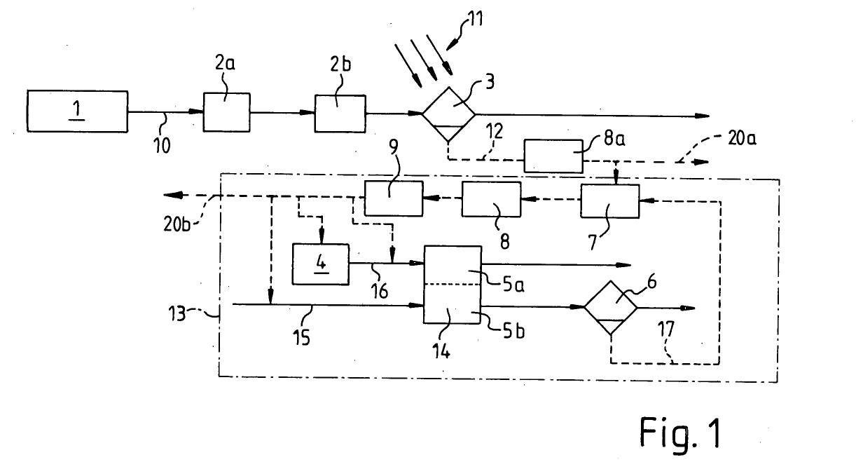

In a principal diagram shown in FIG. 1, a combustion motor is identified with reference numeral 1. In a waste-gas stream 10 from the combustion motor 1 an oxidation catalyst 2a and an optionally provided catalyst NOₓ catalyst 2b are arranged. Behind the catalysts 2a, 2b in a flow direction, a precipitator 3 is provided in accordance with the present invention.

The precipitator 3 can be formed as a passive water precipitator which precipitates water 12 under suitable conditions. For this purpose the complexity and the structural and regulatory expenses of the total system can be maintained relatively low. For example, the precipitator 3 has a baffle plate or the like, on which the condensed water flows off or drops off. The baffle plate can lead to an advantageous whirling of the waste gas stream, so that the precipitation of the water 2 is improved.

In a relatively simple variant of the invention, the precipitator 3 can be formed as a heat exchanger which gives out the heat of the waste gas 10, for example to the environment. A cooling 11 is schematically shown in FIG. 1 by several arrows. The cooling 11 can be improved by special cooling elements such as for example air guiding elements, cooling ribs, cooling coils of an air conditioning device or the like.

The relatively cold, demoisturized waste gas stream 10 is expelled from the vehicle by means of a conventional exhaust device.

The water 12 which is recovered by the precipitator 3 is supplied by a withdrawal conduit or an optionally provided pump 8a to a fuel cell system 13. The fuel cell system 13 includes a fuel cell 14 which has an anode 5a and a cathode 5b. In the variant shown in FIG. 1 a gas generating device 4 is provided, which is formed in particular as a reformer.

The fuel cell 14 is operated with air and with a water containing fuel stream 16 produced by the reformer 4. Water vapor is supplied from the cathode 5b of the fuel cell 14, which is partially withdrawn by a second precipitator 6 from the gas stream. The water 17 recovered by the precipitator 6 is supplied to a water container 7 of the fuel cell device 13. The water container 7 is used simultaneously as a water storage of the precipitator 3 in accordance with the present invention. The water 12, 13 which is stored in it can be supplied by a pump 8 to an optionally provided cleaning unit, in particular an ion exchanger 9.

Frequently the ion exchanger 9 is already available in the fuel cell systems 13. It lowers the conductivity of the water 12, 13, so that a possible short circuiting in the fuel cell 14 is substantially prevented. For this purpose the water 12, 13 is adjusted by the purifier 9 to a conductive value of smaller than 5 μs/cm. The purifier unit 9 can be formed alternatively or additionally for cleaning or removal of hydrocarbon particles, soot particles, etc., so that the impurities which are sometimes available can be efficiently eliminated from the waste gas water 12.

Moreover, a not shown purification unit can purify the water outside the fuel cell system 13 at least partially. This means that for example the water 12, when considered in a flow direction of the water 12, is purified before the container 7. Thereby a removal of hydrocarbon-containing or carbon-containing impurities is of special advantage.

The water 12, 13 which is purified in some cases is supplied possibly to one or both fuel flows 15, 16 of the fuel cell 14 for moisturizing and/or to the reformer 4.

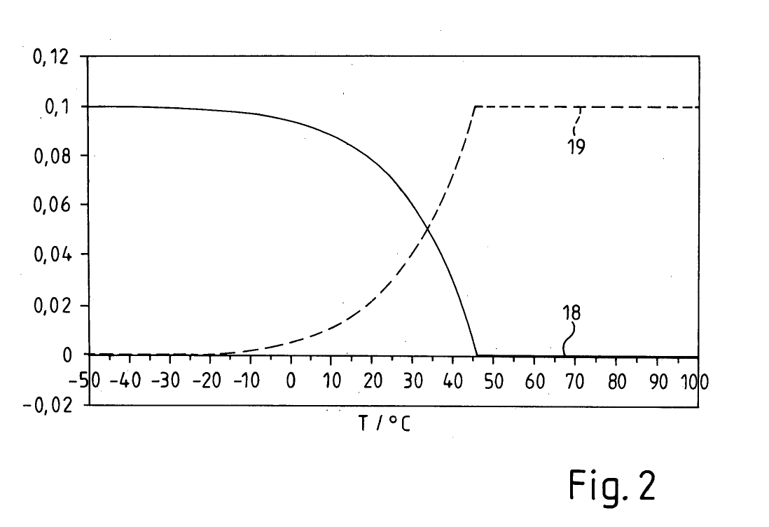

FIG. 2 schematically shows a relationship between a water component in the waste gas and a temperature in the precipitator 3. From the curve 18 the course of the condensated water recovered by means of the precipitator 3 can be seen. The curve 19 shows the course of the water remaining in the waste gas stream. In FIG. 2 a mol stream of the water is shown over the temperature in the precipitator 3 in degrees Celsius. FIG. 2 clearly shows that with a water content in the waste gas of substantially 10%, water is condensated at temperatures under 50° C.

Generally, with the precipitator 3 the precipitator 6 must precipitate less water 17, so that advantageously it consumes less (cooling) energy. The precipitator 3 can operate without energy use, for example by means travel wind or available cooling ribs, etc., or with very low energy consumption, for example for a relatively small feed pump 8a. This leads first of all to the situation that the total efficiency of the system is increased or the so-called parasitic powers of the fuel cell system 13 are significantly reduced.

Basically, a precipitation unit 3 for precipitation of the water 12 from the waste gas stream in a vehicle with a combustion arrangement 1, in particular a combustion motor 1, is advantageous for producing the drive energy of the vehicle. For example the separated water 12 can be used for the windshield wiper device, for cooling purposes or further applications, for example in the combustion motor for gas cooling. Correspondingly, in FIG. 1, for example optionally provided conduits 20a, 20b or branches for further application in the vehicle are shown. These conduits 20a, 20b can be arranged at any points of the system, at which an advantageous branching of the precipitated water 12 is possible.

It will be understood that each of the elements described above, or two or more together, may also find a useful application in other types of constructions differing from the types described above.

While the invention has been illustrated and described as embodied in vehicle with a combustion arrangement and a fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A vehicle, comprising a combustion arrangement formed as a motor selected from the group consisting of a gasoline motor and a diesel motor; a waste gas device associated with said combustion arrangement for withdrawal of a waste gas stream, said waste gas device having at least one precipitating unit for precipitation of water from the waste gas stream.

2. A vehicle as defined in claim 1; and further comprising at least one fuel cell device with a fuel cell unit for producing electrical energy.

3. A vehicle as defined in claim 1; and further comprising at least one pressure generating unit for pressure loading of precipitated water.

4. A vehicle as defined in claim 1; and further comprising at least one water storage for intermediately storing precipitated water.

5. A vehicle as defined in claim 1; and further comprising at least one cleaning unit for cleaning precipitated water.

6. A vehicle as defined in claim 2; and further comprising at least one connecting device provided between said precipitating unit and said fuel cell device for supply of precipitated water to said precipitating unit.

7. A vehicle as defined in claim 2; and further comprising at least one connecting device provided between said precipitating unit and said fuel cell element.

8. A vehicle as defined in claim 2; and further comprising a connecting device provided between said precipitating unit and a conversion unit for chemical conversion of a fuel to a fuel for said fuel cell unit.

9. A vehicle as defined in claim 1, wherein said separating unit is arranged in a bypass of said waste gas device for producing a waste gas partial stream.

10. A vehicle as defined in claim 1, wherein said precipitating unit is formed as a condensation unit for condensation of water.

11. A vehicle as defined in claim 1, wherein said precipitation unit has at least one cooling device for cooling a gas stream.

12. A vehicle as defined in claim 11, wherein said cooling device has at least one cooling element which increases an outer surface.

13. A vehicle as defined in claim 1, wherein said precipitation unit is arranged between a catalytically active waste gas element for catalytic conversion of the waste gas stream and an outflow opening of said waste gas device.
